(19) United States
(12) Patent Application Publication
(10) Pub. No.: US 2009/0029313 A1
(43) Pub. Date: Jan. 29, 2009

(54) Simplified implant cap for tooth implant

(75) Inventor: Chien-Tang Chou, Taipei (TW)

Correspondence Address: Muncy, Geissler, Olds & Lowe, PLLC, P.O. BOX 1364, FAIRFAX, VA, 22038-1364, US

(73) Assignee: Cheng Yih Trading Co., Ltd.

(21) Appl. No.: 11/878,471

(22) Filed: Jul. 25, 2007

(51) Int. Cl. A61C 13/107

(52) U.S. Cl. 433/173; 433/213

(57) ABSTRACT

An implant cap that may fit with a post includes an opened face contacting a tooth socket and having an opening, a closed face opposite to the opened face, and a penetrating portion communicating with the opening and having a diameter corresponding to that of the post. The cap serves as a hemostasis cap for the wound to prevent it from bleeding after the surgery so that a pretty gum profile can be formed and a provisional tooth crown can be guided and formed to facilitate the inserting of the artificial tooth. Also, the cap serves as the expanding cap for the soft tissue of gum to avoid the anesthetization surgery before the artificial tooth is placed. If the patient has to wear the provisional artificial tooth, the implant cap can be formed to protect the post and keep the cleanness therearound when the artificial tooth is being manufactured.

### BACKGROUND OF THE INVENTION

(1) Field of the Invention

The invention relates in general to a simplified implant cap for tooth implant, and more particularly to an implant cap for wound hemostasis during implant surgery and for guiding soft tissue to expand and thus to form a gum profile.

(2) Description of the Prior Art

The artificial tooth implant is a great advance in the current cure for the missing tooth and is different from the conventional artificial tooth, which disadvantageously has the poor chewing feeling, the low stability and the poor exterior, and has to be supported by neighboring teeth. The artificial tooth implant improves the conventional drawbacks of the artificial tooth, looks like the natural tooth and has the high stability, so the user can chew various foods with security. In addition, the artificial implant tooth needs not to be supported by the neighboring teeth, advantageously has the high surgical success rate, and can be continuously used if the implant tooth is well maintained.

The typical artificial implant surgery may be classified into the one-stage tooth implant and the two-stage tooth implant. In the one-stage tooth implant, an artificial root is embedded into an alveolar bone of a missing-tooth area, and the artificial root is then connected to a post with the post being exposed out of a tooth socket. After several months have elapsed, the artificial root is fully combined with the post and the alveolar bone to form a support for the artificial tooth, and a provisional tooth crown and an artificial tooth impression are formed. Finally, the artificial tooth is fit with the post so that the one-stage tooth implant surgery is completed. However, after the artificial root is embedded, the wound is not sewed up and the wound still bleeds or leaks the blood after the surgery. In the period when the artificial root and the alveolar bone are fully combined together, residues tend to accumulate around the post (i.e., in the step between the gum and the tooth socket) and cannot be easily cleaned. So, the phenomenon of wound inflammation tends to occur. In addition, after the wound coalesces, the gum profile matching with the original tooth shape tends to be damaged, and the provisional tooth crown cannot be easily made. Also, the gum has to be anesthetized to make the soft tissue thereof expand before the artificial tooth is embedded, thereby bring the uncomfortable feeling for the patient.

In the first stage of the two-stage tooth implant, the artificial root is also embedded into the gum bone of the missing-tooth area but no post is attached during the embedding process. After several months have elapsed, the artificial root and the gum bone are fully combined together, and the second stage of the surgery is performed. In the second stage of the surgery, the coalesced tooth socket is cut away and the post is connected to the artificial root. Then, the wound is sewed up and the provisional artificial tooth is worn. After the stitches are removed, the provisional tooth crown and the impression of the permanent artificial tooth have to be made. Finally, the permanent artificial tooth is attached to complete the tooth implement surgery. This method can enhance the contact degree between the artificial root and the gum bone. However, the process of manufacturing the provisional artificial tooth is time-consuming and labor-consuming. Similar to the one-stage tooth implant, if the soft tissue of the gum closes, the gum has to be anesthetized so that the soft tissue expands and then the permanent artificial tooth can be attached. Thus, the method is very inconvenient.

### SUMMARY OF THE INVENTION

In view of the problems brought to the patient during the implant surgery, the prevent invention provides an implant cap after many tries and efforts, wherein the problems include the bleeding of the wound after the surgery, the closing of the soft tissue of the gum, and the need of the time-consuming and labor-consuming provision of the provisional artificial tooth. The invention solves the problems of the patient before the implant surgery is finished. The cap serves as a hemostasis cap for the wound to prevent it from bleeding after the surgery so that a pretty gum profile can be formed and a provisional tooth crown can be guided and formed to facilitate the formation of the impression of the artificial tooth. Also, the cap serves as the expanding cap for the soft tissue of gum to avoid the anesthetization surgery before the artificial tooth is placed. If the patient has to wear the provisional artificial tooth, the implant cap can be formed to protect the post and keep the cleanness therearound when the artificial tooth is being manufactured.

The implant cap of the invention is a block to be fit with the post. The block has an opening formed on one side of the block, and a hollow penetrating portion formed in the block. A shape and a diameter of the penetrating portion correspond to a shape and a diameter of the post.

The depth of the penetrating portion corresponds to the length of the post exposed from the tooth socket. If the exposed post is short, the depth of the penetrating portion is the same as the length of the exposed post so that the implant cap covers the post. If the post is long, the other opening may be formed on the other side opposite to the opening so that the post penetrates through the implant cap and extends out of the other opening of the block.

The implant cap may be attached to the patient after the one-stage implant surgery to directly press the soft tissue for hemostasis so that the pretty gum profile can be automatically formed after the wound coalesces and the provisional tooth crown can be easily formed to facilitate the inserting of the artificial tooth. If the patient chooses the two-stage implant surgery, the implant cap may be used to replace the provisional artificial tooth after the post is attached to the patient so that the pretty gum profile can be automatically formed over the tooth socket and the provisional tooth crown can be easily formed to facilitate the inserting of the artificial tooth. If the patient chooses to attach the provisional artificial tooth, the implant cap may be first attached before the provisional artificial tooth is attached to keep the cleanness around the post.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing the invention.

FIG. 2 is an exploded view showing a state of the invention in use.

FIG. 3 shows one state of the invention in use.

FIG. 4 shows another state of the invention in use.

FIG. 5 shows still another state of the invention in use.

### DETAILED DESCRIPTION OF THE PREFERRED EMBODIMENTS

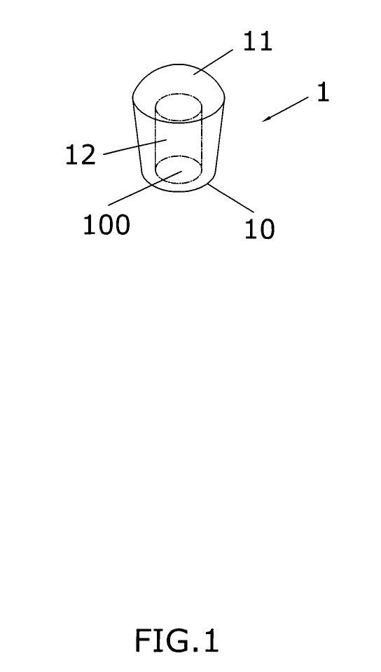

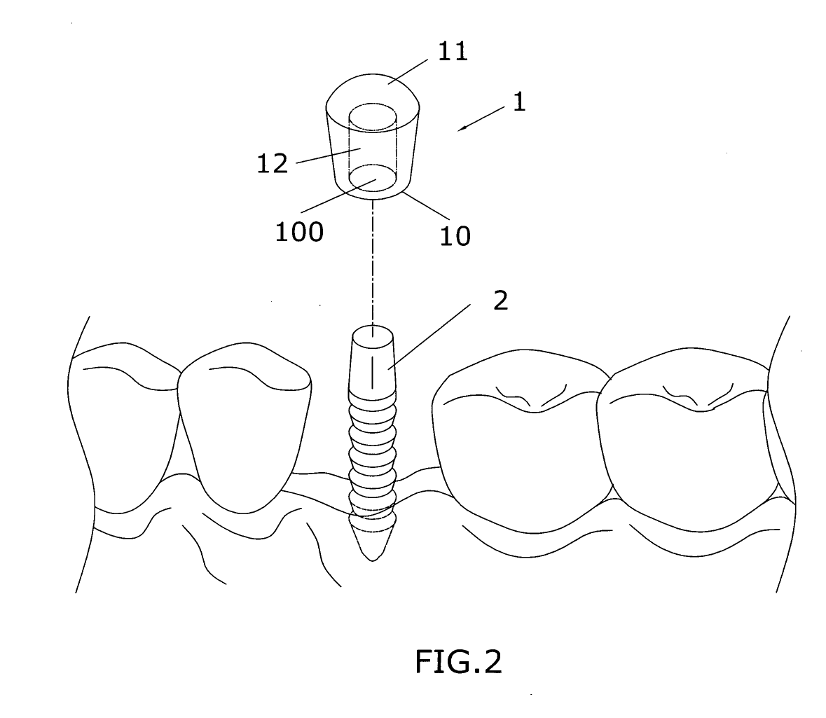

Referring to FIGS. 1 and 2, an implant cap 1 of the invention is a block that may be fit with a post 2 and includes an opened face 10, a closed face 11 and a penetrating portion 12.

The opened face 10 is formed on one side of the block contacting a tooth socket, and is formed with an opening 100 having a diameter corresponding to a diameter of the post 2.

The closed face 11 is formed on the other side opposite to the opened face 10.

The penetrating portion 12 is formed in the block and communicates with the opening 100, and has a shape and a diameter corresponding to those of the post 2.

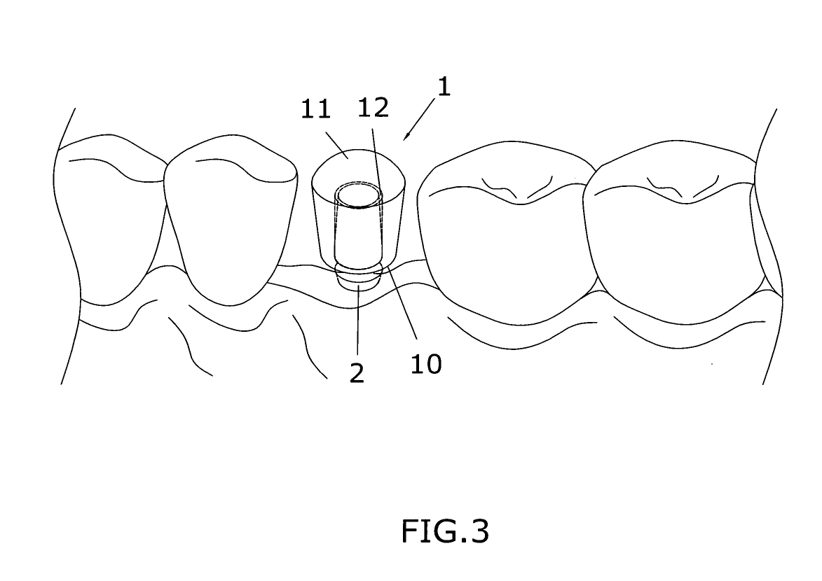

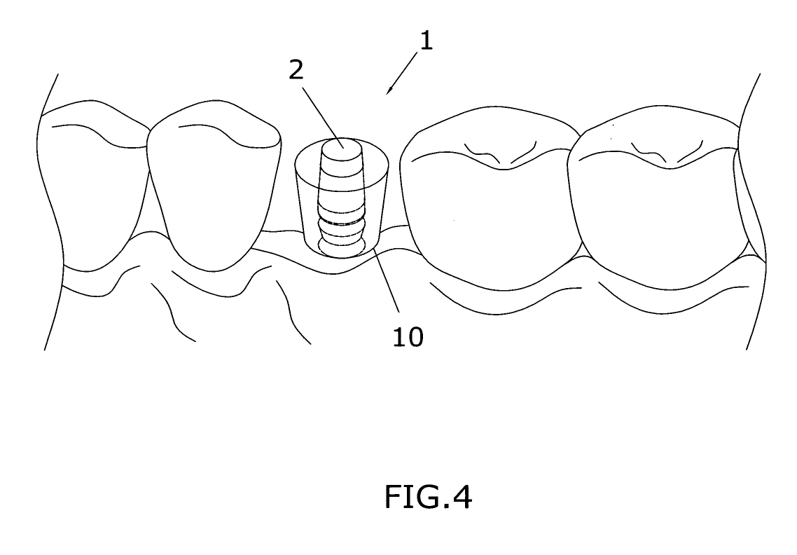

As shown in FIG. 3, the depth of the penetrating portion 12 corresponds to the length of the post 2 exposed from the tooth socket. If the exposed post 2 is short, the depth of the penetrating portion 12 is the same as the length of the post 2 exposed from the outside so that the implant cap 1 covers the exposed post 2. As shown in FIG. 4, if the exposed portion of the post 2 is longer, the other opening may be formed on the closed face 11 so that the post 2 penetrates through the implant cap 1 and extends out of the other opening of the implant cap 1.

As shown in FIGS. 3 and 4, the detailed exterior of the implant cap 1 is not fixed but preferably has a smooth surface to prevent a tongue or the circumferential tissue from being hurt. In one embodiment, the exterior of the implant cap 1 is substantially a cylinder.

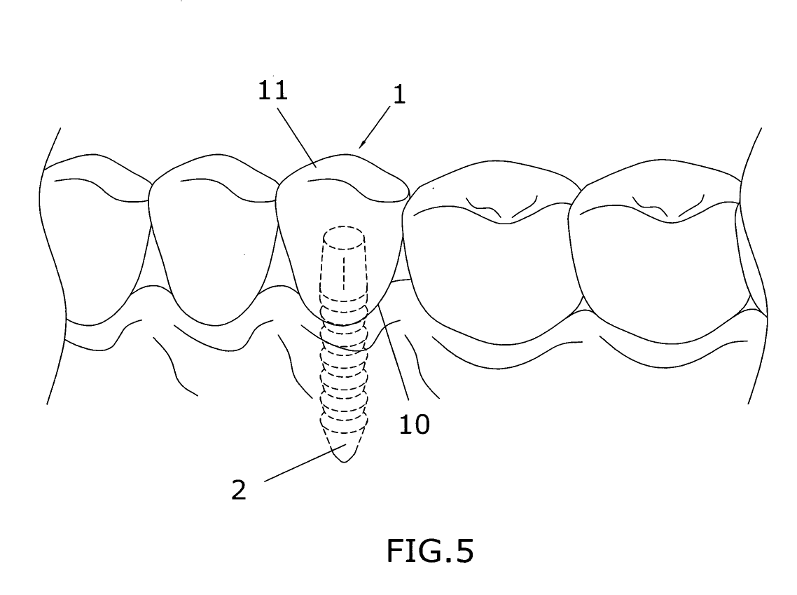

As shown in FIG. 5, the exterior of the implant cap 1 may have a tooth shape in another embodiment so that the implant cap 1 cannot be easily sensed and the better feeling can be obtained.

The implant cap may be attached to the patient after the one-stage implant surgery to directly press the soft tissue for hemostasis so that the pretty gum profile can be automatically formed after the wound coalesces and the provisional tooth crown can be easily formed to facilitate the inserting of the artificial tooth or the impression of the artificial tooth can be easily formed. If the patient chooses the two-stage implant surgery, the implant cap may be used to replace the provisional artificial tooth after the post is attached to the patient so that the pretty gum profile can be automatically formed over the tooth socket and the provisional tooth crown can be easily formed to facilitate the inserting of the artificial tooth and the impression of the artificial tooth can be easily formed. If the patient chooses to attach the provisional artificial tooth, the implant cap may be first attached before the provisional artificial tooth is attached to keep the cleanness around the post.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

1-5. (canceled)

6. An implant cap assembly for a tooth socket comprising:
a) a post located in the tooth socket and having an exposed portion extending outwardly from the tooth socket; and
b) a implant cap being a block having a penetrating portion extending through the implant cap from a first surface to a second surface of the implant cap, the first surface is located on a side opposite to the second surface, the penetrating portion having a size corresponding with a size of the exposed portion,
wherein the exposed portion of the post is inserted into the penetrating portion from the first surface and extends outwardly from the penetrating portion beyond the second surface of the implant cap.

7. The implant cap assembly according to claim 6, wherein the implant cap is a cylinder.
